(19) United States
(12) Patent Application Publication
(10) Pub. No.: US 2007/0188687 A1
(43) Pub. Date: Aug. 16, 2007

(54) PROTECTIVE DEVICE FOR A LIQUID CRYSTAL DISPLAY

(76) Inventor: Wang-Lung She, Fengshan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/422,683

(22) Filed: Jun. 7, 2006

(30) Foreign Application Priority Data
Feb. 16, 2006 (TW) 095262602

(51) Int. Cl. G02F 1/1333

(52) U.S. Cl. 349/122

(57) ABSTRACT

A protective device for a liquid crystal display has a protective plate and at least one suspension arm detachably attaching the protective plate to an outer frame of the liquid crystal display. The protective plate has a top edge and at least one engaging cutout defined at the top edge. Each suspension arm has a clamping element to engage the engaging cutout on the protective plate and optionally contains at least one flexible section so that the suspension arm is deformable to correspond to liquid crystal displays in different size. By having the described arrangement of elements, the protective device has a simple structure and is convenient in assembly. Moreover, the at least one suspension arm does not cause visual obstruction to a screen of the liquid crystal display in use.

### BACKGROUND OF THE INVENTION

1. Field of the Invention

The present invention relates to a protective device for a liquid crystal display, and more particularly to a protective device that can be conveniently attached to a liquid crystal display, has a simple structure and keeps the appearance of the liquid crystal display neat to view the full screen on the liquid crystal display without obstruction.

2. Description of Related Art

Liquid crystal display is a planer and thin monitor and has various types such as twisted nematic (TN), super twisted nematic (STN), thin film transistor (TFT) and metal/insulator/metal (MIM). Take TFT as an example, a TFT liquid crystal display has basic elements including a glass substrate, color filters, polarizers, driving integrated circuits, a liquid crystal layer, isotropic membranes, backlighting modules, ITO conductive membranes and a frame enclosing other elements inside. The TFT liquid crystal display has widely substituted for conventional cathode ray tube (CRT) now. Because each unit on a panel of the liquid crystal display has even distances to other units adjacent around, pixels in line do not have differences or deformation. Moreover, the liquid crystal display has diminished size, high mobility, zero radiation, no pollution problem, and excellent energy-saving capability and then gradually substitutes the conventional CRT display to become the main current of display products. However, the panel of the liquid crystal display is soft and easily penetrated by sharp objects so that the panel needs a protective device.

A conventional protective device on the market is a hanging-type protective glass that covers adjusting buttons on the liquid crystal display and has an outer frame combined with glass and multiple securing devices. When the protective glass mounts on the liquid crystal display, the multiple securing devices attach to a top of the frame of the liquid crystal display and the outer frame performs an inharmonic appearance to the liquid crystal display especially when the liquid crystal display has special design. When the hanging-type protective glass does not have securing devices attached below, the glass will swing easily, bump the panel and cause noise. Moreover, the hanging-type protective glass has high manufacturing cost and can not be modified easily because its structure is complex.

Another protective device is a protective membrane made of acryl that directly attaches to the panel of the liquid crystal display with adhesive or a double-sided tape at corners. However, the adhesive or the double-sided tape easily deteriorates and then loses its adhesive capability so that the protective membrane easily falls from the panel suddenly. Therefore, the protective membrane is not durable. Additionally, when size of the protective membrane is not corresponding to the screen of the panel, the protective membrane has to attach to the screen directly and the adhesive stains the screen consequently.

### SUMMARY OF THE INVENTION

To overcome drawbacks of the conventional protective devices for the liquid crystal display, a novel protective device is provided to eliminate the drawbacks.

A main objective of the present invention is to provide a protective device for the liquid crystal display, wherein the protective device is conveniently attached to the liquid crystal display, completely protects the liquid crystal display and keeps the liquid crystal display neat in appearance.

Another main objective of the present invention is to provide a protective device for the liquid crystal display, wherein the protective device has simple structure in small size and does not cover adjusting buttons on the liquid crystal display.

To achieve the foregoing objective, the protective device in the present invention comprises:

a protective plate being transparent and having a top edge and at least one engaging cutout defined at the top edge; and

at least one suspension arm attached to the protective plate, each suspension arm having a claming element formed at one end of the suspension arm to engage one engaging cutout on the transparent plate.

Preferably, each suspension arm at least one flexible section to facilitate deformation of the suspension arm and to adapt to an outer frame of the liquid crystal display for suspension.

Thereby, the protective device is conveniently assembled and mounted on the liquid crystal display without obstructing a screen of the liquid crystal display.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a protective device in accordance with the present invention;

FIG. 2 is an operational perspective view of the protective device in FIG. 1;

FIG. 3 is a perspective view of another embodiment of the protective device in accordance with the present invention; and

FIG. 4 is a perspective view of still another embodiment of the protective device in accordance with the present invention.

### DETAILED DESCRIPTION OF THE PREFERRED EMBODIMENT

A protective device for a liquid crystal display in accordance with the present invention comprises a protective plate and at least one suspension arm detachably attaching the protective plate to an outer frame of the liquid crystal display. The protective plate has a top edge and at least one engaging cutout defined at the top edge. Each suspension arm has a clamping element to engage the engaging cutout on the protective plate and optionally contains at least one flexible section so that the suspension arm is deformable to correspond to liquid crystal displays in different size. By having the described arrangement of elements, the protective device has a simple structure and is convenient in assembly. Moreover, the at least one suspension arm does not cause visual obstruction to a screen of the liquid crystal display in use.

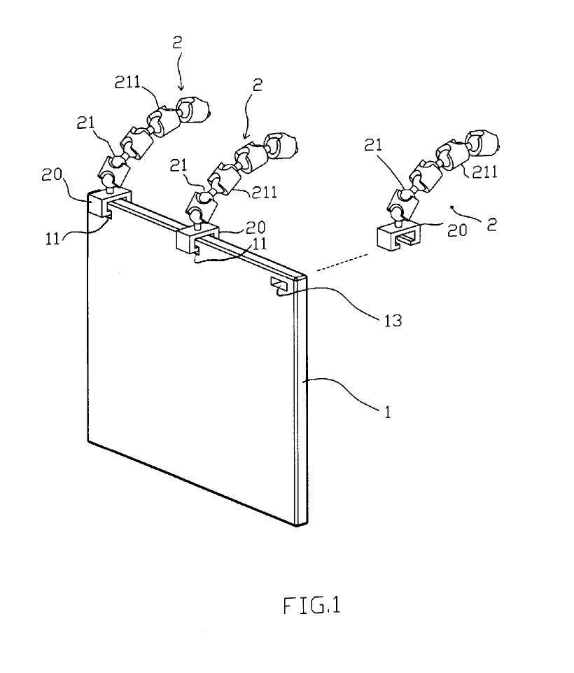

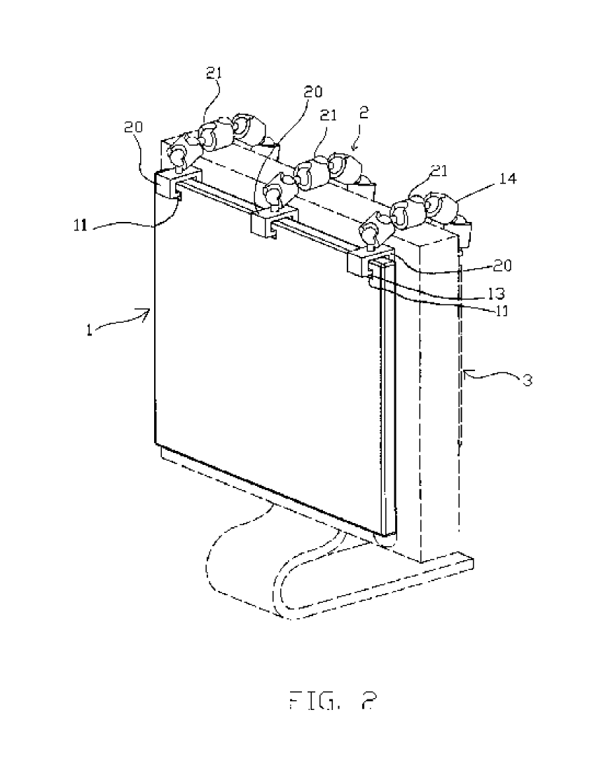

With reference to FIGS. 1 and 2, a first preferred embodiment of the protective device in accordance with the present invention comprises a protective plate 1 and three suspension arms 2.

The protective plate 1 is frameless and made of transparent material such as glass, acryl or plastic having excellent transparency. Preferably, the protective plate has anti-glare efficiency. Moreover, the protective device in the present invention preferably comprises a top edge and three engaging cutouts 11 or through hole 1 3 defined on the top edge.

The three suspension arms 2 are correspondingly and respectively engaged with the three engaging cutouts 11 on the protective plate 1. Each suspension arm 2 has a clamping element 20 formed at one end to combine with the corresponding engaging cutout 11 to provide a firmly securing efficiency. The suspension arm 2 is completely composed of multiple connecting blocks 211 and multiple dumbbell-shaped joints respectively connected between two adjacent connecting blocks 211 so that the suspension arm 2 is deformable to correspond to shape of the liquid crystal display 3.

As shown in FIG. 2, the protective plate 1 combines with the suspension arms 2 first by using the clamping elements 20 to clamp the engaging cutouts 11 on the protective plate 1. Then, the protective device hangs over the liquid crystal display 3 and the suspension arms 2 are adjusted to correspond with the shape of the liquid crystal display 3 until the protective plate 1 snugly attaches to the screen of the liquid crystal display 3. Thereby, the protective plate 1 is installed in front of the liquid crystal display 3. Because the protective plate 1 is frameless, the protective plate does not influence the appearance of the liquid crystal display 3. Moreover, the suspension arms 2 mounted at the top edge of the protective plate 1 so that the protective device has no element set below to keep controlling buttons at bottom of the liquid crystal display 3 revealed for convenient operation.

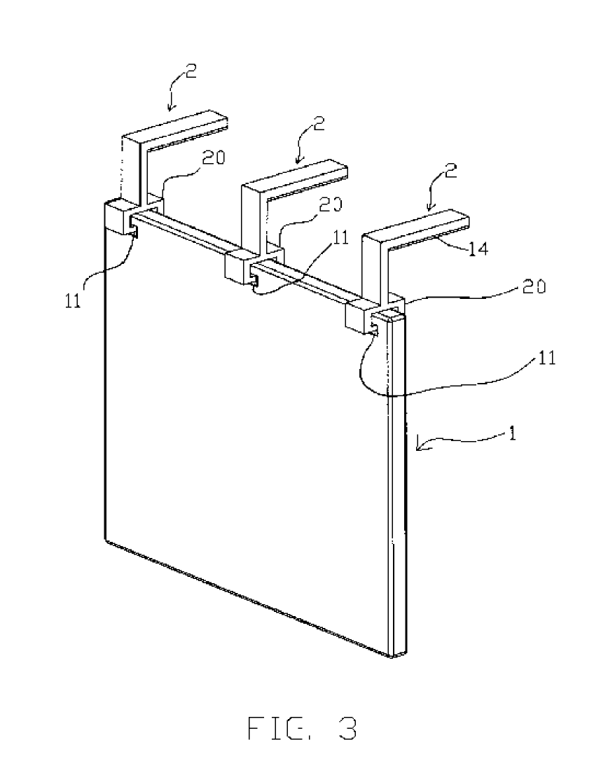

As shown in FIG. 3, a second preferred embodiment of the protective device for a liquid crystal display in accordance with the present invention comprises the same structure except the suspension arms are modified into L-shaped arms 2′. Each L-shaped arm 2′ combines with the protective plate 1 by the clamping elements 20 as shown in the first embodiment and has a front section and a rear section. In order to keep the L-shaped arm 2′ stably mounting on the liquid crystal display 3, a bottom face on the rear section of the L-shaped arm 2′ is applied with glue or Velcro® 14 to stick on the liquid crystal display 3 because the L-shaped arm 2′ is not flexible.

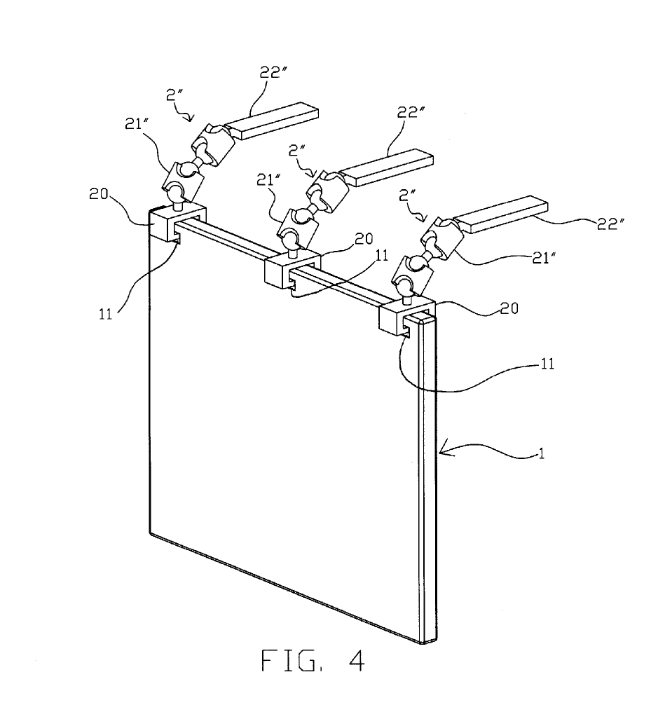

As shown in FIG. 4, a third preferred embodiment of the protective device for a liquid crystal display in accordance with the present invention comprises the same structure except the suspension arms are modified into a hybrid arms 2″. Each hybrid arm 2″ combines with the protective plate 1 by the clamping elements 20 as shown in the first embodiment and has a front section and a rear section. The front section is a flexible section composed of the multiple connecting blocks 21″ and the multiple dumbbell-shaped joints to make the hybrid arm 2″ deformable. The rear section is an extension rod 22″ as shown in the second preferred embodiment to directly attach to a backside of the liquid crystal display.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A protective device for a liquid crystal display, the protective device comprising:
a protective plate being transparent and having a top edge and at least one engaging cutout defined at the top edge; and
at least one suspension arm attached to the protective plate, each suspension arm having a claming element formed at a distal end of the suspension arm to engage one of the at least one engaging cutout on the transparent plate.

2. The protective device as claimed in claim 1, wherein the protective plate is frameless and made of material selected from the group comprising: glass, acryl and plastic having excellent transparency.

3. The protective device as claimed in claim 1, wherein the protective plate has anti-glare efficiency.

4. The protective device as claimed in claim 1, wherein the suspension arm is composed of multiple connecting blocks and multiple dumbbell-shaped joints respectively extending between adjacent two of the multiple connecting blocks.

5. The protective device as claimed in claim 1, wherein the suspension arm is an L-shaped arm.

6. The protective device as claimed in claim 1, wherein the suspension arm has at least one flexible section composed of multiple connecting blocks and multiple dumbbell-shaped joints respectively extending between adjacent two of the multiple connecting blocks.

7. The protective device as claimed in claim 6, wherein the suspension arm comprises a front section in form of one flexible section and a rear section in form of an extension rod.

8. The protective device as claimed in claim 1, wherein each clamping element on the corresponding suspension arm is transparent.
